(19) United States
(12) Patent Application Publication
(10) Pub. No.: US 2006/0159522 A1
(43) Pub. Date: Jul. 20, 2006

(54) Unitary submarine pipeline spoiler

(76) Inventor: Michael Paul Edfeldt, Helena, AL (US)

Correspondence Address: 24IP LAW GROUP USA, PLLC, 12 E. LAKE DRIVE, ANNAPOLIS, MD, 21403, US

(21) Appl. No.: 11/037,991

(22) Filed: Jan. 18, 2005

(51) Int. Cl. F16L 1/12

(52) U.S. Cl. 405/159

(57) ABSTRACT

A method and apparatus for stabilizing and burying a conduit in a waterbed is disclosed. A plurality of spoilers are placed on the conduit at longitudinally and radially different positions to promote self-burial, reduce vortex-induced vibration, prevent upheaval buckling, minimize future corrective work by continuous reburial of the under water conduit or pipeline.

### CROSS-REFERENCE TO RELATED APPLICATIONS

U.S. patent application Ser. No. 10/797,319 entitled “Submarine Pipeline Spoiler, filed by inventor Michael Edfeldt on Mar. 10, 2004.

### STATEMENT REGARDING FEDERALLY SPONSORED RESEARCH OR DEVELOPMENT

Not applicable.

### FIELD OF THE INVENTION

The present invention relates to the field of burying underwater pipelines, and more specifically to a device for promoting self-burial and/or stabilization of underwater pipelines.

### BACKGROUND OF THE INVENTION

A smooth and circular conduit often has a tendency toward self-burial, but the effect often is insufficient, so that the conduit is easily exposed again and/or the time for self-burying is very long, with the inherent danger of damage by anchors, fishing gears or the like. In view regulations of several governments that require that a conduit be buried so much within one year that there is at least a covering layer of a height of 20 cm above it, various methods of burying conduits have been proposed.

Prior methods of burial have included the making of trenches by dredging, by cutting with rotary cutters or by strong water jets and to position the pipeline or conduit therein. Such prior methods have been realized in such a way that the conduit has lowered to the bottom underwater during the preparation of such a trench. After positioning of the conduit in the trench, the trench may be filled up above the conduit with the material which first has been removed for making the trench so as to obtain sufficient earth material above the conduit, so that it is not again exposed by the stirring action of the water flows along the bottom. These traditional methods of burying conduits suffered from numerous problems, including, but not limited to, adverse environmental impact and cost.

A method of self-burial of a conduit in a seabed using protruding parts such as fins was disclosed in U.S. Pat. No. 4,648,745, entitled “Method and Device for Burying a Conduit in the Bottom of a Waterbed,” which is incorporated by reference herein in its entirety. That patent disclosed a method in which protrusions such as fins are provided on or in the vicinity of the conduit, which cause disturbances in the flow of water near the conduit to erode the bottom of the waterbed in such a way that the conduit will be buried.

It has appeared that by application of the fins, horizontal water flows near the conduit generate flow disturbances and/or turbulences, swirling up, dragging with it and removing the bottom material to the side of and in many cases also below the conduit, so that the conduit sinks into the bottom by its own weight, which process proceeds until the conduit is sufficiently buried, after which the depression, which is thereby formed in the proximity of the conduit, silts up so that so much earth will cover the conduit that it remains buried safely.

The method of that patent was realized in such a way that the protruding parts were provided at a horizontal distance from the conduit and extending substantially parallel thereto, provided on or in the bottom, and this possibility could be combined with the application of one or more protruding parts on the conduit itself. That design was believed to be particularly advantageous when the horizontal flows along the bottom in the water are in one direction only instead of switching to and fro by tide currents.

The patent further noted that tilting of the conduit may occur in certain environments, and if the conduit may easily tilt to a more considerable extent, it was possible to provide a number of protruding parts, distributed over a greater part of or over the entire periphery of the conduit so that always the parts protruding in a direction to be effective for the erosion generate sufficient disturbance in the water flow for burying erosion. For example, in order to guide a downwardly directed swirl generated at the luff side and directed downwardly along the wall of the conduit, an embodiment was disclosed wherein the conduit had a radial longitudinal fin in an inclined position in the upper part e.g. at an angle of about 45.degree. to the horizontal direction. An even better guiding of said swirl was obtained by curving such a fin concavely downwardly. If the water flow was alternating as by the tide, there would normally be two such fins on the conduit.

The patent suggested several different fin structures and methods for attaching the fin to the conduit. For example, the patent taught that in one embodiment the fin may consist of metal or of a sufficiently strong plastic material and may be welded to the wall of the conduit or be formed onto a plastic coating layer of the conduit. In another embodiment, the patent taught that the fin could be provided on a wrapping, e.g., a coating of the conduit from a suitable plastic material or artificial rubber, separate from the conduit such that the fin is attached to the conduit by securing the wrapping to the conduit. In another embodiment, the fin may form one integral unit with a wrapping of a conduit and the fin may be connected by a narrower part to the wrapping.

Several advances in the use of protrusions or fins to promote self-burial of pipelines are disclosed in European Patent Specification No. EP 0466219 B1, entitled “Pipeline with Ground Anchors,” which is incorporated by reference herein in its entirety. That European patent disclosed a “seat” and “spoiler” structure in which the spoilers would be mounted to a seat that would “grab” across part of the outer surface of a pipe. The seat and spoiler would then be kept in place on the pipe by metal straps. The two-piece seat and spoiler structure was used because the fin could be made of a suitable material such that it would provide the desired self-burial effect and the joint between the fin and seat would provide the fin with sufficient flexibility that it would not break when hit underwater.

In practice, the spoilers typically have a two-piece structure having a seat or saddle 112 and a fin 114, such as is shown in FIG. 1-2. The fins and seats typically are secured to the pipe 10 using metal straps. In practice, these two-piece spoilers have been manufactured using various materials, including materials known as “PVC” and

A further advance was disclosed in European Patent Specification No. EP 0717223 B 1, entitled “Assembly of pipelines intended to lie on a seabed and saddle for securing a second pipeline to a first pipeline,” which is incorporated by reference herein in its entirety. That patent disclosed a structure of the seat for protrusions from a pipeline in the form of a saddle for accommodating a second pipe.

The conventional submarine pipeline spoilers generally functioned well but suffered from a variety of deficiencies, such as the fins being too flexible or too rigid, the fins and seats having to be manufactured separately and installation on a pipeline requiring assembly of the two-piece spoiler.

### SUMMARY OF THE INVENTION

The present invention provides an improved apparatus for stabilizing and burying a conduit in a pipeline. The apparatus comprises a unitary seat and fin construction in which the apparatus is formed from a material having a combination of a tensile strength of approximately 46-52 N/mm² and an elongation at break of approximately 20-70%. Additional characteristics of the material in a preferred embodiment are a density of approximately 1.45 g/cm³, a tensile strength of approximately 46-52 N/mm², an elongation at break of approximately 20-70%, a Charpy Impact of approximately 5-10 KJ/m², a shore hardness of approximately D80-81 Shore A/D, a thermal expansion coefficient of approximately 0.08 mm/m/° C., and surface resistance of approximately 10E13 ohms.

Still other aspects, features, and advantages of the present invention are readily apparent from the following detailed description, simply by illustrating preferable embodiments and implementations. The present invention is also capable of other and different embodiments, and its several details can be modified in various respects, all without departing from the spirit and scope of the present invention. Accordingly, the drawings and descriptions are to be regarded as illustrative in nature, and not as restrictive.

### BRIEF DESCRIPTION OF THE DRAWINGS

The invention of the present application will now be described in more detail with reference to preferred embodiments of the architecture and method, given only by way of example, and with reference to the accompanying drawings, in which:

FIG. 1 is a perspective view of a conventional alignment of prior art spoilers for self-burial of a conduit or pipeline.

FIG. 2 is a cross-section of a two-piece prior art spoiler for self-burial of a conduit or pipeline.

FIG. 3 is a cross-sectional view of a unitary spoiler in accordance with the present invention.

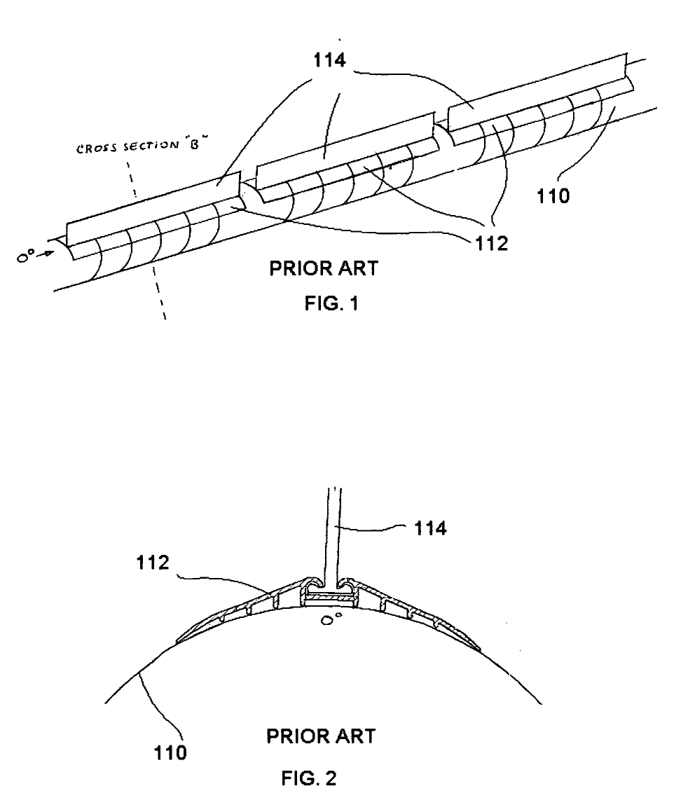

### DESCRIPTION OF THE PREFERRED EMBODIMENTS

The present invention presents a new submarine pipeline spoiler design that provides numerous advantages in terms of ability to handle impacts from anchors, fishing lines etc., ease of manufacture, cost of manufacture and ease of installation.

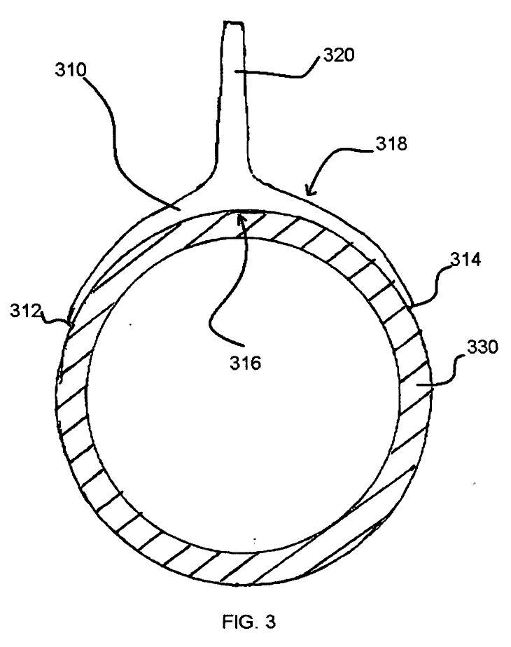

As shown in FIG. 3, the present invention comprises a unitary seat and fin arrangement in which the seat and fin are manufactured together as a single unit. The unitary structure has a seat 310 and a fin 320.

In a preferred embodiment the fin is located approximately at the radial center of the seat roughly halfway between the sides 312, 314 of the seat. The seat preferably is a solid structure having a concave inner surface 316 for placement adjacent a conduit and an outer surface 318. The thickness of the seat between the inner concave surface and the outer surface preferably increases from the sides 312, 314 of the seat toward the fin 320. The fin 320 protrudes from the seat and preferably is tapered away from the seat 310. The ends of the fin may be angles, squared or tapered, as in known in the art. The fin preferably has one or more openings near the seat to accommodate a band, strap or other known means for securing a spoiler to a pipeline. This unitary structure may be used not only on a spoiler as shown in FIG. 3, but also may be used with other types of spoilers such as what is known as a “piggy-back spoiler,” such as that disclosed in EP 0717223 B1.

The unitary spoiler of the preferred embodiment is manufactured from a material having the following characteristics: tensile strength of approximately 46-52 N/mm²; an elongation at break of approximately 20-70%; a density of approximately 1.45 g/cm³; a tensile strength of approximately 46-52 N/mm²; an elongation at break of approximately 20-70%; a Charpy Impact of approximately 5-10 KJ/m²; a shore hardness of approximately D80-81 Shore A/D; a thermal expansion coefficient of approximately 0.08 mm/m/° C.; and surface resistance of approximately 10E13 ohms. The tensile strength, elongation at break, and Charpy impact of the material provide a combination of sufficient strength and sufficient flexibility when manufactured in a unitary seat and fin structure to provide superior performance to prior art submarine pipeline spoiler structures. The other characteristics lists above are representative of the material used in the preferred embodiment and have certain benefits associated with them but are not necessary to the invention. One material having characteristics in these ranges is known to the inventor as “UPVC,” which previously has been used in the manufacture of two-piece spoilers but heretofore has not been used or thought to be suitable for a unitary seat and fin spoiler.

In other embodiments, the seat portion of the unitary spoiler may take on other forms, such as with a seat having a plurality of ribs of varying length extending therefrom for placement adjacent a conduit.

While the foregoing invention has been described in terms of its preferred embodiments, it should be understood that various modifications may be made thereto without departing from the spirit and scope of the invention as defined in the appended claims. It is intended that all such modifications fall within the scope of the appended claims.

1. A submarine pipeline spoiler comprising:
a seat; and
a fin extending from said seat; wherein
said fin and seat are formed as a unitary structure from a material having a tensile strength in the range of approximately 46-52 N/mm² and a Charpy impact of approximately 5-10 KJ/m₂;
said seat comprises a an inner surface for placement adjacent to a conduit, an outer surface for placement away from said conduit, and first and second sides extending away from said fin, wherein said fin is located approximately halfway between said two sides of said seat; and
a thickness of said seat between said inner and outer surfaces increases from said first side toward said fin.

2. A submarine pipeline spoiler according to claim 1, wherein said material forming said unitary seat and fin structure has an elongation at break of approximately 20-70%.

3. A submarine pipeline spoiler according to claim 1, where said material forming said unitary seat and fin structure has a density of approximately 1.45 g/cm³.

4. A submarine pipeline spoiler according to claim 1, wherein said material forming said unitary seat and fin structure has thermal expansion coefficient of approximately 0.08 mm/m/° C.

5. A submarine pipeline spoiler according to claim 1, wherein said material forming said unitary seat and fin structure has a surface resistance of approximately 10E13 ohms.

6. A submarine pipeline spoiler assembly comprising:
a seat; and
a fin extending from said seat; wherein
said fin and seat are formed as a unitary structure from a material having a tensile strength in the range of approximately 46-52 N/mm²; a Charpy impact of approximately 5-10 KJ/m₂; and an elongation at break of approximately 20-70%.

7. A submarine pipeline spoiler according to claim 6, where said material forming said unitary seat and fin structure has a density of approximately 1.45 g/cm³.

8. A submarine pipeline spoiler according to claim 6, wherein said material forming said unitary seat and fin structure has thermal expansion coefficient of approximately 0.08 mm/m/° C.

9. A submarine pipeline spoiler according to claim 6, wherein said material forming said unitary seat and fin structure has a surface resistance of approximately 10E13 ohms.

10. (canceled)

11. A submarine pipeline spoiler according to claim 1 wherein said inner surface comprises a curved surface.

12. A submarine pipeline spoiler according to claim 10 wherein said seat comprises a plurality of ribs.

13. A submarine pipeline spoiler according to claim 10 wherein said seat is solid.

14. A submarine pipeline spoiler according to claim 1 wherein said inner surface comprises a continuous surface from said first side of said seat to said second side of said seat.

15. A submarine pipeline spoiler according to claim 1 wherein said inner surface comprises a concave surface.
